(19) United States
(12) Patent Application Publication
(10) Pub. No.: US 2025/0217680 A1
(43) Pub. Date: Jul. 3, 2025

(54) AUTONOMOUS ORCHESTRATION SYSTEM FOR DECISION LIFECYCLE MANAGEMENT WITH INTEGRATED TRACEABILITY

(71) Applicant: Intellectual Frontiers LLC, Silver Spring, MD (US)

(72) Inventor: Shahid N. Shah, Silver Spring, MD (US)

(73) Assignee: Intellectual Frontiers LLC, Silver Spring, MD (US)

(21) Appl. No.: 19/081,752

(22) Filed: Mar. 17, 2025

(51) Int. Cl. G06N 5/043; G06N 20/00

(52) U.S. Cl. CPC G06N 5/043; G06N 20/00

(57) ABSTRACT

A computer-controlled decision lifecycle management system and method are provided for orchestrating a decision lifecycle. The system is to classify a decision type as one of a decision made by a manual intervention, autonomously by an artificial intelligence (AI) system, or collaboratively by both the AI system and the manual intervention. The system is to trigger an initiation of the decision based on a triggering event and generate a decision token representing the decision. The system collects evidence in the form of computer-executable data from a plurality of data sources and associates the evidence with a decision token to enable traceability. An AI-based analysis module of the system processes the evidence by executing one or more AI algorithms and generate a computer executable decision recommendation based on processed evidence.

### BACKGROUND

### Technical Field

The embodiments herein generally relate to a machine-implemented system and method for managing lifecycle of computer-executable decisions and, more particularly, to a hybrid hardware-software system and method for managing and optimizing evidence-driven autonomous decision-making workflows.

### Description of the Related Art

Traditional decision-making within organizations has relied significantly on middle management, which historically acted as an intermediary for collecting, analyzing, and synthesizing evidence to drive business outcomes. However, with the increasing adoption of artificial intelligence (AI) technologies, these roles are undergoing significant transformation, enabling automation of numerous evidence-driven decision-making tasks previously handled by human intermediaries. This shift highlights a pressing need for advanced systems capable of coordinating autonomous AI-driven decision-making while maintaining collaboration with human stakeholders.

Moreover, existing decision-making platforms, predominantly software-based, exhibit inherent shortcomings, such as latency in processing voluminous data streams, insufficient security measures to protect sensitive decision workflows, and computational inefficiencies in executing complex AI tasks. These limitations hinder their applicability in environments requiring real-time responsiveness, robust traceability, and secure decision orchestration across distributed infrastructures.

There is a need for a system to optimize decision-making workflows that not only replaces traditional non-computerized functions but also introduces a scalable and secure architecture adaptable to diverse environments.

### SUMMARY

An embodiment herein provides a computer-controlled decision lifecycle management system for orchestrating a decision lifecycle, the system comprising: a decision categorization module that classifies a decision type as one of a decision made by a manual intervention, a decision made autonomously by an artificial intelligence (AI) system, or a decision made collaboratively by both an AI system and the manual intervention, based on a set of predefined criteria; a decision initiation module that triggers an initiation of the decision based on a triggering event, wherein the triggering event comprises one or more of a hardware input, a user request, a predefined schedule, wherein the decision initiation module is to generate a decision token representing the decision; an evidence aggregation module communicatively coupled to a plurality of data sources distributed across discrete and remote locations, wherein the evidence aggregation module is to collect evidence in the form of computer-executable data from the plurality of data sources and associate the evidence with a decision token to enable traceability; and an AI-based analysis module that processes the evidence by executing one or more AI algorithms and generate a computer executable decision recommendation based on processed evidence.

The system may comprise a decision approval module that receives the decision recommendation and facilitate either automated or manual approval based on one or more predefined approval rules, wherein the decision token is updated upon approval to reflect an approval status; and a decision execution module that executes the decision upon approval by triggering one or more actions, wherein the execution includes activating a hardware component, and updating the decision token to reflect an execution status. The decision execution module may execute the decision upon the approval by triggering the one or more actions, and the execution may include requesting a user for manual performance to conduct the execution and updating the decision token to reflect the execution status accordingly. The system may comprise an audit and compliance module that records an immutable and verifiable record of the decision lifecycle, including the evidence, the decision recommendation, the approval status, and the execution status, stored on a blockchain ledger for auditability and compliance with one or more predefined requirements.

The decision execution module may comprise a hardware actuator interface that receives one or more execution instructions and trigger a physical operation in the hardware component; and a monitoring subsystem that collects telemetry data during the execution and update the decision token with one or more operational metrics and detected anomalies. The hardware component may comprise one or more of a wearable device, a medical device, a continuous monitoring device, a drug delivery device, a surgical equipment, a therapeutic equipment, and a diagnostic device, and edge node associated with a user. The evidence aggregation module may tokenize the evidence using a blockchain function to create a unique, immutable identifier for each piece of the evidence; and transmit a tokenized evidence to a distributed ledger for secure storage and retrieval, such that the tokenized evidence is tamper-proof and accessible for audit and traceability.

The AI-based analysis module may perform a real-time analysis of the evidence by leveraging edge computing resources deployed at the remote locations of the data sources; and adapt the decision recommendation dynamically based on changing inputs, using a reinforcement learning algorithm to optimize decision-making over time, wherein the changing inputs comprises one or more of the predefined criteria and the evidence collected from the data sources. The decision categorization module may dynamically update the predefined criteria for decision classification based on historical decision outcomes and performance metrics stored in a decision analytics repository; and notify the decision initiation module when a reclassification of the decision type is required.

The decision initiation module may comprise a sensor integration interface that receives data streams from one or more of an IoT-enabled device, a wearable device, data stream serving as the triggering events for initiating the decision; and a priority assignment mechanism that ranks multiple simultaneous triggering events based on a predefined priority hierarchy. The evidence aggregation module may validate an integrity of the collected evidence using a digital signature verification process; and filter irrelevant or redundant data prior to associating it with the decision token to improve processing efficiency. The audit and compliance module may track an access permission to data corresponding to the decision lifecycle using a role-based access control mechanism; and log user interactions with the data, including one or more of modifications and approvals. The evidence aggregation module may comprise a SQL-centric resource surveillance mechanism that monitors and analyzes system resources, data inputs, and workflow execution associated with the plurality of data sources in real-time, and the resource surveillance mechanism may use SQL-based queries to gather the evidence in the form of computer-executable data.

Another embodiment provides a computer-implemented method for managing a decision lifecycle, the method comprising classifying, by a decision categorization module, a decision type as one of a decision made by a manual intervention, a decision made autonomously by an artificial intelligence (AI) system, or a decision made collaboratively by both the AI system and the manual intervention, based on predefined classification criteria; triggering, by a decision initiation module, an initiation of the decision in response to a triggering event, wherein the triggering event includes one or more of a hardware input, a user request, or a predefined schedule, and generating a decision token representing the decision; collecting, by an evidence aggregation module communicatively coupled to a plurality of data sources distributed across discrete and remote locations, evidence in the form of computer-executable data from the plurality of data sources and associating the evidence with the decision token for traceability; processing, by an AI-based analysis module, the evidence by executing one or more AI algorithms to generate a computer-executable decision recommendation; and updating the decision token to reflect the status of the decision lifecycle stages.

The method may comprise receiving, by a decision approval module, the decision recommendation; approving the decision through one or more predefined approval rules. The approval process may be either automated or involves manual intervention. The method may comprise updating the decision token to reflect the approval status. The method may comprise executing, by a decision execution module, the approved decision by triggering one or more actions. The execution may include activating a hardware component or requesting manual performance of the execution. The metho may comprise updating the decision token to reflect an execution status based on the performed actions. The collecting of the evidence by the evidence aggregation module may comprise tokenizing the evidence using a cryptographic hash function to create a unique and immutable identifier; and storing the tokenized evidence on a distributed ledger for tamper-proof auditability and traceability.

The processing of the evidence by the AI-based analysis module may comprise performing a real-time analysis of the evidence by leveraging edge computing resources deployed at the remote locations of the data sources; and dynamically adapting the decision recommendation based on changing inputs including at least the evidence using a reinforcement learning algorithm. The AI-based analysis module may utilize hardware acceleration components including at least one of specialized graphics processing units (GPUs) and field-programmable gate arrays (FPGAs) to execute computationally intensive AI algorithms, and the processing of the evidence may comprise distributing computational tasks between the edge computing resources and central processing resources based on latency requirements and computational complexity; routing security-sensitive decision tasks to trusted execution environments with hardware-level isolation; and executing less sensitive but computationally intensive analysis on specialized AI accelerators. The distribution of computational tasks creates measurable improvements in both decision throughput and response times compared to centralized decision processing.

The method may comprise implementing a federated learning framework that enables the AI-based analysis module to learn from distributed data sources across the edge nodes without compromising data privacy; utilizing a multi-layered adaptive security framework that dynamically adjusts security measures based on a criticality level of the decision being processed and real-time threat assessments; collecting telemetry data from hardware components through a monitoring subsystem that enables continuous evaluation of decision effectiveness and automatic refinement of future decision processes; and providing a graphical user interface that allows authorized users to visualize decision paths, associated evidence, and real-time adjustments to the decision workflow.

### BRIEF DESCRIPTION OF THE DRAWINGS

The features of the disclosed embodiments may become apparent from the following detailed description taken in conjunction with the accompanying drawings showing illustrative embodiments herein, in which:

FIG. 1 illustrates an architecture of an ecosystem for orchestrating lifecycle of computer executable decisions, in accordance with an embodiment.

FIG. 2 illustrates a decision lifecycle manager (DLM) for orchestrating decision lifecycle of the computer executable decisions, in accordance with an embodiment.

FIG. 3 illustrates the decision lifecycle manager communicatively coupled to various other systems, in accordance with an embodiment.

FIG. 4 illustrates a method diagram illustrating a computer-implemented method for managing the decision lifecycle, in accordance with an embodiment.

FIG. 5 illustrates a computer executable decision lifecycle, in accordance with an embodiment.

FIG. 6 illustrates an exemplary blockchain-configured ecosystem architecture containing the DLM, in accordance with an embodiment.

FIG. 7 illustrates a representative hardware environment for practicing various embodiments.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the following detailed description, reference is made to the accompanying drawings which form a part hereof, and in which is shown by way of illustration specific embodiments in which the embodiments herein may be practiced. These embodiments, which are also referred to herein as “examples,” are described in sufficient detail to enable those skilled in the art to practice the embodiments herein, and it is to be understood that the embodiments may be combined, or that other embodiments may be utilized and that structural, logical, and electrical changes may be made without departing from the scope of the embodiments herein.

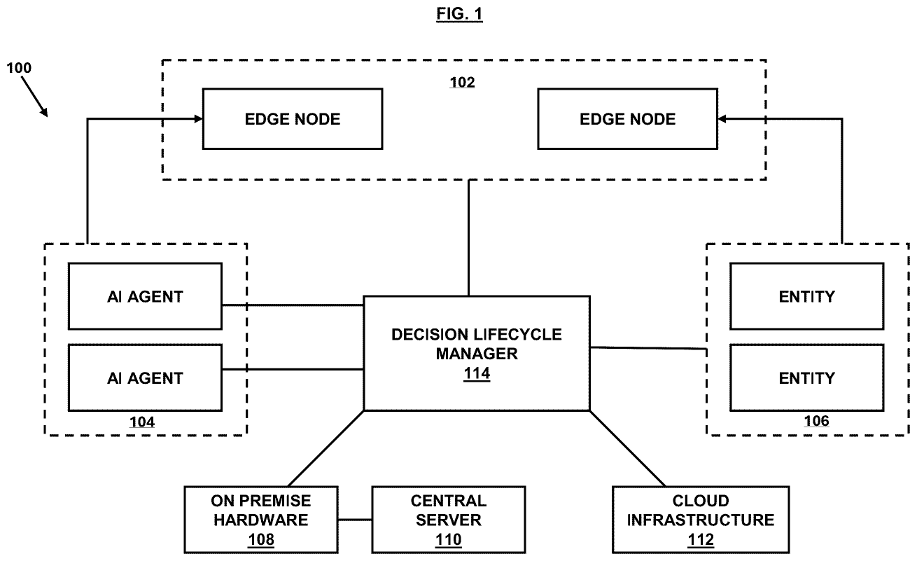

FIG. 1 illustrates an architecture of an ecosystem for orchestrating lifecycle of computer executable decisions referred to as decision lifecycle, in accordance with various embodiments.

Referring to FIG. 1, the ecosystem may include a plurality of edge nodes and one or more artificial intelligence (AI) agents (also referred to as AI agent 104) or alternatively referred to as AI systems. The edge nodes (also referred to as edge node 102) may be situated at geographically disparate locations, each performing localized data processing and providing localized data streams. The edge nodes 102 may be communicatively connected to the one or more AI agents (also referred to as AI agent 104), which may be configured to execute specific AI algorithms for analyzing and interpreting the data streams provided or generated by the edge nodes 102 and make necessary decision recommendations.

The ecosystem may include a decision lifecycle manager 114 connected communicatively with the edge nodes 102 and various other components. The decision lifecycle manager 114 may interact with each of the aforementioned components such as the plurality of edge nodes 102, AI agents 104, entities (also referred to as entity 106), etc to manage various stages of the decision lifecycle, from initiation to final execution and traceability of the computer executable decisions.

The DLM (also referred to as decision lifecycle manager 114) may also include or be coupled to on-premise hardware 108, which may comprise physical computing resources, such as servers or specialized hardware, used for executing decision-making processes or facilitating data collection, analysis, and communication with various components. This on-premise hardware 108 may be configured to interface with the edge nodes 102.

The ecosystem may also include cloud infrastructure 112. The cloud infrastructure 112 may be depicted as a centralized computing resource that may provide scalable processing power and storage capabilities for executing complex decision-making algorithms and storing voluminous datasets. The DLM 114 may employ this hybrid architecture wherein a combination of the on-premise hardware 108 and the cloud infrastructure 112 may provide a balance between cost, performance, and scalability. The cloud infrastructure 112 may be used for non-real-time analytics and long-term data storage, while the on-premise hardware 108 may be used for providing real-time responsiveness.

As shown, the on-premise hardware 108 may include or be coupled to a central server 110. The ecosystem may allow and maintain a real-time synchronization between the distributed edge nodes 102 and the central server 110, for efficient decision management across various locations wherein the various components of the ecosystem may be located. The synchronization may be achieved using high-throughput messaging systems which provides data consistency and reliability across the various ecosystem participants and devices. In an event of communication failure, a built-in disaster recovery system may enable a mechanism to ensure data integrity through redundant storage and failover protocols.

The hybrid architecture may be configured to provide necessary support so that role of the AI systems in business decision-making can be considered in addition to human-based decision making. This allows the AI systems (Also referred to as AI agent 104) and the human agents such as the entities 106 to function together, with the AI system (Also referred to as AI agent 104) taking over routine, evidence-driven decisions and the human agents focusing on predefined matters that may require human or manual intervention. For example, the AI systems 104 may handle repetitive tasks such as approving standard transactions, while the human agents may be utilized to exceptions that require more nuanced analysis as defined in the predefined criteria that is computer executable.

The ecosystem provides a multi-layered, distributed architecture where the decision lifecycle manager 114 may be configured to orchestrate the interactions between the various systems of the ecosystem to enable dynamic, real-time decision-making across various environments and participants of the ecosystem through use of human interventions and automation to optimize efficiency and minimize unnecessary cost spending across organizations.

In embodiments, the AI agents 104 may be separately located from the DLM 114 but communicatively coupled with the DLM 114 to handle automation and AI based tasks. In some embodiments, the AI agents 104 or AI systems 104 may be included within the DLM 114 as part of the DLM 114 to handle automation and AI based tasks required in orchestrating the computer executable decisions of the decision lifecycle.

In embodiments, the term “entities 106,” as utilized herein, may refer to a plurality of participants or stakeholders within the ecosystem also referred to as decision lifecycle management ecosystem, each operably interacting with one or more components of the ecosystem. The entities 106 may include, without limitations, individuals, organizational units, or autonomous systems, which may act as decision initiators, decision validators, or recipients of decision outputs, and the like. The entities 106 may interface with the ecosystem at various stages of the decision lifecycle, either via direct manual interaction or through automated communication protocols executed by the AI system 104, depending on their designated roles and functionalities within the ecosystem architecture.

In certain embodiments, the entities 106 may include human participants responsible for providing contextual inputs or performing the manual interventions at critical junctures in the decision lifecycle. For example, the entities 106 may initiate or approve or review the computer executable decisions by inputting requests or commands through a user interface communicatively coupled to the decision lifecycle manager 114 or by validating a decision recommendation provided by the decision lifecycle manager 114. The manual interventions may be tracked by associating the interactions with corresponding decision tokens as will be discussed later in the document, thereby ensuring traceability and auditability.

In some embodiments, the entities may comprise or be associated with computational or automated systems, such as IoT-enabled devices, monitoring subsystems (also referred to as monitoring subsystem 226), or external software platforms, that generate or transmit data streams for use by the decision lifecycle manager 114.

The entities 106 may act as decision recipients, receiving outputs from the decision lifecycle manager 114 for actionable implementation. The entities 106 may include or be associated with operational machinery, therapeutic devices, or external stakeholders requiring real-time insights or control outputs derived from the decision lifecycle manager 114 to perform their tasks that require decision making that can be facilitated by the decision lifecycle manager 114. The ecosystem may configure the entities to facilitate bidirectional communication, allowing them to provide feedback or telemetry data to the decision lifecycle manager 114 for subsequent updates to the decisions made or recommended by the decision lifecycle manager 114. Each of the entities 106 may be associated with an edge node 102 such as the edge nodes 102 discussed herein and illustrated in FIG. 1. It must be appreciated that only two edge nodes 102 and two AI agents 104 or AI systems 104, and two entities 106 are illustrated in FIG. 1, however, each of these can be only one or even more than two in accordance with embodiments without limitations.

The edge nodes 102 may be deployed to collect the data locally, perform preprocessing, and then communicate with the decision lifecycle manager 114 or one or more of the on-premise hardware 108 and the cloud infrastructure 112 coupled with the DLM 114, which may then route the data to the decision lifecycle manager 114, in embodiments. This may allow the computer executable decisions to be made in real time without overwhelming the decision lifecycle manager 114 or the central server 110. The edge nodes 102 may use specific models such as NVIDIA Jetson for AI inference at respective edges, thereby providing necessary processing capabilities in a compact form factor. The edge nodes 102 may be designed with redundancy and failover capabilities to ensure continuous operation, even if individual components fail.

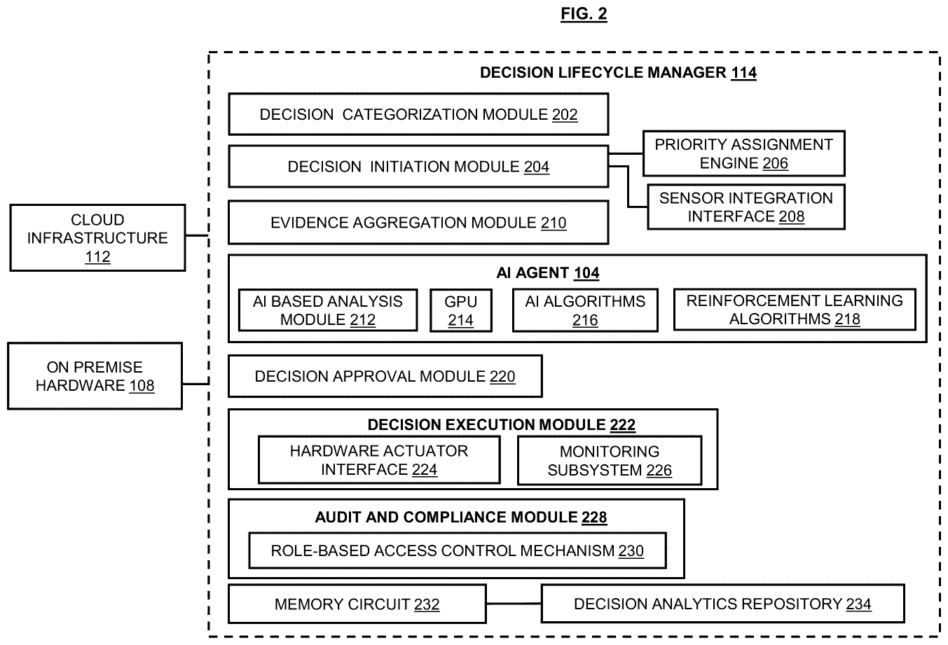

In various embodiments, the AI agents 104 may use specialized hardware such as GPUs (also referred to as GPU 214) as shown in FIG. 2 (e.g., NVIDIA A100), ASICs, or FPGAs (e.g., Intel Stratix 10) to handle computationally intensive tasks such as natural language inference, predictive modeling, and deep learning. These components may allow the AI agents 104 to handle parallel computations effectively, significantly speeding up AI-driven tasks of the decision lifecycle manager 114. In some embodiments, power optimization techniques, such as dynamic voltage and frequency scaling, may be used to reduce energy consumption while maintaining high performance by the AI agents 104.

The decision lifecycle management system 114 implements specialized hardware-software integration that provides concrete technical improvements over conventional decision management systems. Specifically, the hardware acceleration provided by the GPUs 214 and specialized edge computing devices 102 creates a technological solution that enables real-time processing of complex evidence streams that would be impossible using general-purpose computing resources. The system's architecture distributes computational loads between edge nodes 102 and central processing components 110, 112 based on latency requirements and computational complexity, resulting in measurable improvements in decision throughput and response times compared to centralized decision systems.

FIG. 2 illustrates a detailed architecture of the decision lifecycle manager (DLM) 114 for orchestrating the decision lifecycle of the computer executable decisions, in accordance with various embodiments. Referring to FIG. 2 and FIG. 1, the DLM 114 is discussed herein. The DLM 114 may operate as a centralized and orchestrating component interfacing remotely with the plurality of edge nodes 102. The DLM 114 includes or is communicatively coupled to at least one AI agent 104 (also referred to as AI system), on-premise hardware 108, and the cloud infrastructure 112 described in FIG. 1. The DLM 114 is communicatively connected to the entities 106. The DLM 114 may be configured to execute a multi-stage process encompassing decision categorization, initiation, evidence aggregation, AI-based analysis, approval, execution, and audit and compliance functionalities.

The DLM 114 may include a decision categorization module 202, which may be operatively configured to classify a decision type based on predefined classification criteria. The decision categorization module 202 may categorize the computer executable decisions (referred to as simply decisions for simplicity purpose) as either requiring manual intervention, autonomous execution by the AI agent 104, or a collaborative process involving both AI and manual inputs through the AI agent 104 and a human agent from among the human agents discussed above. The classification may be dynamic and adaptively updated based on historical decision outcomes or performance metrics stored within a memory circuit 232 of the DLM 114. The memory circuit 232 may include a decision analytics repository 234. In another embodiment, the memory circuit 232 may be communicatively and operatively coupled separately to the DLM 114. In some embodiments, the memory circuit 232 me be included within the DLM 114 such as shown in FIG. 2.

The DLM 114 further comprises a decision initiation module 204, which may be configured to trigger the initiation of the decision lifecycle based on a triggering event. The triggering event may include inputs such as a hardware signal from an IoT-enabled device, a user-generated request, or a predefined schedule. After initiation, the decision initiation module 204 may be configured to generate a unique decision token, representing the decision, which may be subsequently updated throughout the lifecycle stages for traceability and auditability according to various stages and status. The decision initiation module 204 may be configured to incorporate a priority assignment engine 206 to rank simultaneous triggering events based on a predefined hierarchy and a sensor integration interface 208 for receiving data streams from the IoT-enabled device that nay be distributed at a remote location.

The DLM 114 may include an evidence aggregation module 210. The evidence aggregation module 210 may be communicatively coupled to a plurality of geographically distributed data sources such as the edge nodes 102, and may be configured to collect, validate, and filter a computer executable evidence (also referred to as evidence interchangeably) that is relevant to the decision lifecycle and for making decision recommendations. The evidence collected may be tokenized using blockchain or cryptographic functions to generate immutable identifiers for secure storage and retrieval as will be discussed later in the document. The evidence aggregation module 210 may be configured to accept only validated, non-redundant, and integrity-verified evidence and associate it with the decision token, thereby facilitating efficient and reliable AI-based analysis 212 of the evidence to make the decision recommendations throughout the decision lifecycle.

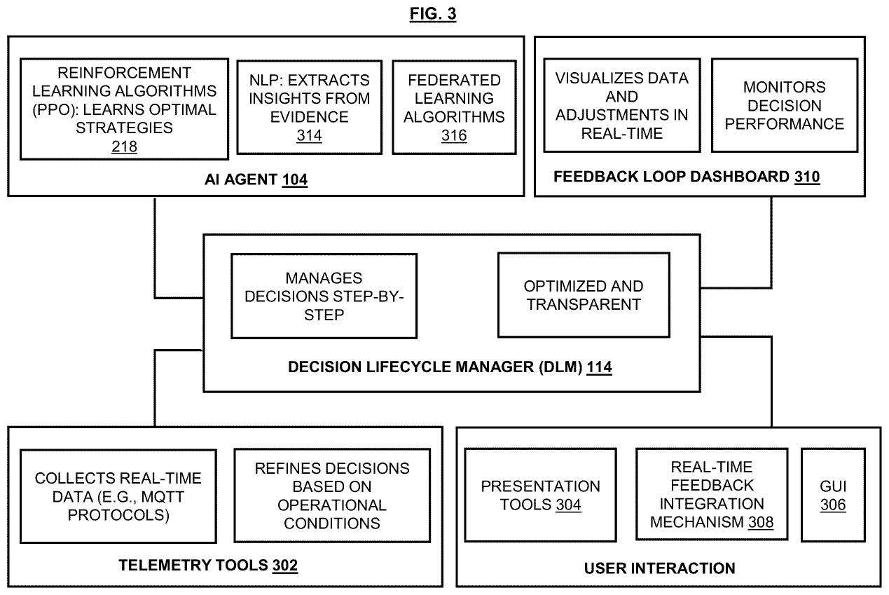

The AI agent 104 of the DLM 114 may include an AI-based analysis module 212 that may process the evidence using one or more AI algorithms 216, generating the decision recommendations based on processed evidence. The AI-based analysis module 212 may employ reinforcement learning algorithms 218 as shown in FIG. 3 to dynamically adapt the decision recommendations in response to changing input criteria or the input signal, thereby optimizing decision-making over time. The AI-based analysis module 212 may leverage edge computing resources for real-time analysis of the evidence obtained from the edge nodes 102 associated with various devices and humans such as the entities 106 discussed above, thereby minimizing latency and enhancing computational efficiency.

The DLM 114 may include a decision approval module 220 that may be configured to facilitate review and approval of the decision recommendations generated by the AI-based analysis module 212. Depending on predefined approval rules, the decision approval process by the decision approval module 220 may involve either automated mechanisms or manual interventions or a combination of both. After the approval, the decision token may be updated to reflect the decision's approval status for traceability and compliance.

The DLM 114 may include a decision execution module 222 that may be configured to execute an approved decision by triggering specific actions. The decision execution module 222 may support diverse execution methods, including activating a hardware component, such as a diagnostic or therapeutic device, or requesting manual performance by a user. The decision execution module 222 may include a hardware actuator interface 224 for transmitting execution instructions and a monitoring subsystem 226 for collecting telemetry data during the execution. An execution status and detected operational metrics may be updated, in accordance with various embodiments.

The decision lifecycle manager 114 produces tangible, real-world effects by controlling physical systems through the hardware actuator interface 224. For example, when deployed in healthcare environments, the system 100 can autonomously analyze patient telemetry from medical devices through the monitoring subsystem 226, make evidence-based treatment recommendations via the AI-based analysis module 212, and upon appropriate approval through the decision approval module 220, directly adjust therapeutic equipment parameters. This creates transformative improvements in patient outcomes by reducing decision latency in time-critical scenarios while maintaining full traceability and accountability of each decision through the audit and compliance module 228. The technical integration with physical actuators creates a concrete application that goes beyond mere data processing.

The DLM 114 may include an audit and compliance module 228 that may be integrated within the DLM 114 to ensure traceability and compliance with regulatory or organizational requirements by maintaining an immutable record of the decision lifecycle. The audit and compliance module 228 may employ a distributed ledger for storing the evidence, decision recommendations, approvals, and the execution statuses. The audit and compliance module 228 may be configured to track access permissions and user interactions through a role-based access control mechanism 230, logging modifications and approvals for enhanced auditability.

The DLM 114, as depicted in FIG. 2, represents a robust and centralized orchestration system capable of managing complex decision lifecycles within the ecosystem, in some embodiments. The integration of the DLM 114 with the edge nodes 102, entities 106, on-premise hardware 108, and the cloud infrastructure 112 may enable real-time, scalable, and secure decision-making processes across diverse operational environments, leveraging a seamless combination of automation and human intervention to optimize outcomes.

The decision lifecycle manager's modules 202, 204, 210, 212, 220, 222, 228 are implemented as discrete hardware-software components with defined interfaces that form an integrated system architecture. The evidence aggregation module 210 incorporates specialized hardware processors, such as those described in connection with the on-premise hardware 108, optimized for pattern matching and data validation, enabling efficient pre-processing of incoming evidence streams before they reach the AI analysis components 212. This hardware-accelerated evidence processing creates a specialized computing system that transforms the abstract concept of decision management into a concrete technological implementation with significant enhancements over conventional computer systems performing similar functions.

FIG. 3 illustrates the decision lifecycle manager 114 communicatively coupled to various other systems in embodiments of the present invention. The decision lifecycle manager 114 may be configured to manage the decisions from the initiation to the execution through the decision lifecycle such that at each stage the decisions may be computer executable. The DLM 114 may dynamically map the evidence to specific decision points, thereby ensuring transparency and auditability. The DLM 114 may use a graphical user interface (GUI 306) that may be configured to allow the entities 106 or users to visualize a decision path and the evidence associated with the computer executable decision at each stage. The GIU may be configured to provide human interaction with the DLM 114.

The DLM 114 may include or be communicatively coupled to the reinforcement learning algorithms 218 and natural language processing algorithms of the AI agent 104 that may be implemented to extract insights from the computer executable evidence and continuously optimize a decision workflow of the decision lifecycle including execution of the decision by the edge nodes 102 and associated entities 106 and devices. The reinforcement learning algorithms 218 such as Proximal Policy Optimization (PPO) and the like without limitations may be used to learn optimal strategies for decision-making based on historical data and trends. In some embodiments, federated learning algorithms 316 may be employed in the DLM 114 to allow the DLM 114 or the associated AI based analysis module 212 (or the AI system) in particular to learn from the distributed data sources across the edge nodes 102 without compromising data privacy.

In embodiments, the DLM 114 may collect telemetry data using telemetry tools 302 from the edge nodes 102 and various other hardware components to refine decision processes and the decision recommendations. The decision making processes may be adjusted based on changing operational conditions, thereby ensuring optimal performance. The data may flow from the edge nodes 102 to the DLM 114 and the associated central server 110 and be monitored using telemetry protocols that may collect the telemetry data. In embodiments, the telemetry protocols may include such as MQTT without limitations. The telemetry protocols may ensure real-time data availability.

The DLM 114 may be communicatively and operatively coupled to a feedback loop dashboard 310 that may be configured to allow the human/users to visualize the telemetry data and understand how various adjustments are made in real time in the computer executable decision-making processes and the workflows.

The DLM 114 may include presentation tools 304 for orchestrating interactions between the AI agent 104 and human/user decision-makers such as from among the entities 106 who may intervene the computer executable decision lifecycle based on the decision recommendations by the DLM 114. The presentation tools 304 may be configured to present the decision recommendations to the entities 106 in a clear, actionable manner, and human/user inputs may be effectively integrated back into the decision-making process for the DLM 114 to further process the decision workflows through the entire lifecycle as needed. The presentation tools 304 may include such as a user dashboard or GUI 306 that may be configured to allow the entities 106 to adjust one or more decision parameters and provide feedback so that the AI agent 104 can learn from the feedback accordingly to refine the decision workflow and the decision recommendations for future decision making. The presentation tools 304 may also include a real-time user feedback integration mechanism (also referred to as real-time feedback integration mechanism 308) that may be configured to allow the human/user inputs to immediately affect the decision parameters, thereby providing a dynamic and adaptive decision capability to the DLM 114.

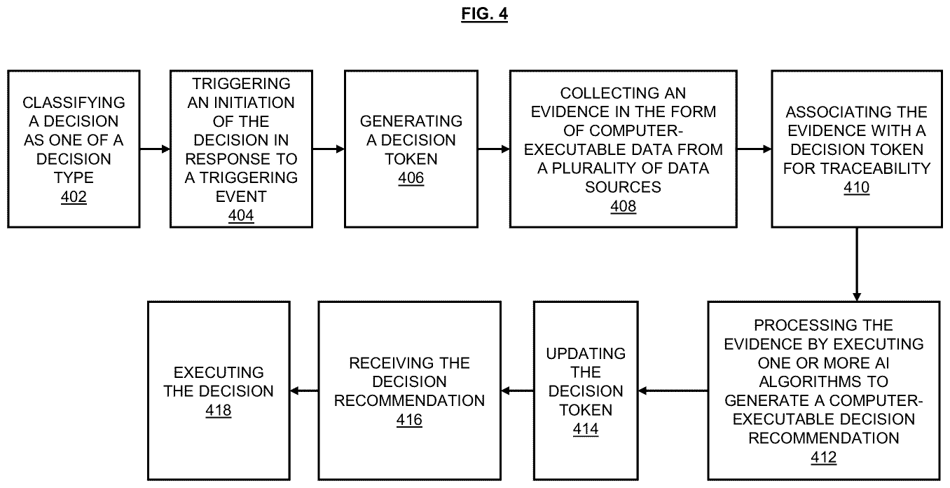

FIG. 4 illustrates a method diagram illustrating a computer-implemented method for managing the decision lifecycle. At step 402, the method includes classifying, by the decision categorization module 202, a decision type as one of the decision made by the manual intervention, the decision made autonomously by the artificial intelligence (AI) system or AI agent 104, or the decision made collaboratively by both the AI system 104 and the manual intervention, based on predefined classification criteria.

At 404, the method includes triggering, by the decision initiation module 204, an initiation of the decision in response to the triggering event, wherein the triggering event includes one or more of the hardware input, user request, or the predefined schedule as discussed above as well in the document.

At 406, the method includes generating the decision token representing the decision.

At 408, the method includes collecting, by the evidence aggregation module 210 communicatively coupled to the plurality of data sources distributed across the discrete and remote locations. The evidence is in the form of the computer-executable data obtained from the plurality of data sources such as the edge nodes 102.

At 410, the method may include associating the evidence with the decision token for traceability.

At 412, the method includes processing, by the AI-based analysis module 212, the evidence by executing AI algorithms 216 to generate the computer-executable decision recommendation.

At 414, the method includes updating the decision token to reflect the status of the decision lifecycle stages.

In embodiments, the method may include receiving, by the decision approval module 220, the decision recommendation at 416. The process of approving the decision may be made through one or more predefined approval rules. The approval process may either be automated or may involve the manual intervention. The method may include updating the decision token to reflect the approval status once the decision is approved or rejected as the case may be.

At 418, the method may include executing, by the decision execution module 222, the approved decision by triggering one or more actions. The execution may include activating the hardware component or requesting manual performance of the execution. The decision token may be updated to reflect the execution status based on performed one or more actions.

Once the evidence is collected, the method may include tokenizing the evidence using a cryptographic hash function to create a unique and immutable identifier. The tokenized evidence may be stored on a distributed ledger for tamper-proof auditability and traceability as will be described later in the document.

The method may further include performing a real-time analysis of the evidence by leveraging edge computing resources deployed at the remote locations of the data sources. The method may include dynamically adapting the decision recommendation based on changing inputs including at least the evidence using the reinforcement learning algorithms 218.

In various embodiments, the Decision Lifecycle Manager (DLM) 114 may be responsible for managing, tracking, and optimizing the lifecycle of computer executable decisions from its initiation to execution and beyond. The DLM 114 may provide a seamless coordination between the AI agents 104, human decision-makers, and various hardware components in the ecosystem thereby ensuring that every computer executable decision is fully traceable, auditable, and compliant. The DLM 114 may maintain integrity, transparency, and efficiency of the decision making processes in a wide range of industries, including such as healthcare, finance, and government.

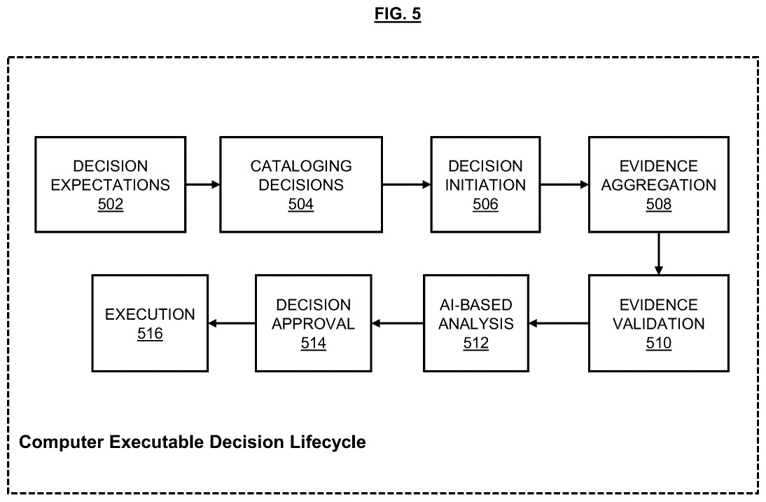

FIG. 5 illustrates the computer executable decision lifecycle in an exemplary embodiment. The DLM 114 oversees various steps of the decision lifecycle such that the computer executable decision progresses systemically throughout the lifecycle. The lifecycle includes a first stage of decision expectations as shown at 502, wherein before any decision is made, the DLM 114 understands what decisions are required based on computer executable inputs provided to the DLM 114. This may involve such as setting expectations for which types of decisions need to be made and categorizing them based on their nature and importance. The categorization of the decisions is done by the categorization module. The decision expectations help the DLM 114 define whether a decision should be made by humans, AI agents 104, or a combination of both.

The next stage in the lifecycle of the decision-making processes involves cataloguing of the decisions at 504. The computer executable decisions may be catalogued to help the DLM 114 understand roles of humans and machines (such as the AI agents 104) in the decision-making process. The process of cataloging involves categorizing the decisions into three main types including decisions made by humans alone, decisions made by autonomous systems such as the AI agents 104, and decisions made collaboratively by the humans and the machines (alternatively referred to as autonomous system or AI agent 104 without any limitations of singular and plural usage). This ensures that the right level of autonomy and oversight is applied to each computer executable decision and helps the DLM 114 determine an appropriate workflow and strategy for orchestrating the decisions in each category. The cataloguing of the decisions allows the DLM 114 to understand opportunities where AI can replace traditional human roles, thereby enabling more efficient and scalable decision-making.

The next stage is initiation of the computer executable decision at 506. The decision initiation module 204 is configured to initiate this stage of the decision lifecycle upon detection of the one or more predefined triggering events, as facilitated by an interaction of the hardware systems, edge nodes 102, and the central server 110. The triggering events may include, without limitation, data inputs generated by such as the sensors or devices or hardware components, user requests transmitted through user interfaces, business rules encoded within operational software frameworks, or the predefined schedules programmed into the DLM 114 as discussed above in the document. The triggering events may be detected, captured, and communicated by the edge nodes 102 or the central server 110 to the decision lifecycle manager (DLM) 114 for subsequent processing.

After the initiation of the decision lifecycle upon detection of the triggering event, the decision initiation module 204 may become operable to generate the decision token. The decision token may serve as an immutable and unique identifier for the decision being initiated. The decision token may be created through a cryptographic process, which may involve blockchain technology, to ensure that the entire decision lifecycle is traceable to its origin. The blockchain-based implementation of the decision token generation may allow tamper-proof tracking and auditability, providing a secure and verifiable mechanism for lifecycle traceability.

In some embodiments, in addition to the decision token, the decision initiation module 204 may assign a Foreign Integration Identifier (FII) to each computer executable decision. The FII may be designed to function as a unique identifier across multiple systems or platforms for integration and interoperability between the DLM 114 and other external decision-making frameworks or systems. The interoperability may facilitate synchronization and correlation of the computer executable decision executed within the DLM 114 with those processed by the external systems. This allows the DLM 114 to maintain decision lifecycles coherence across disparate operational environments communicatively connected with the DLM 114. In an example, the FIG. 1 illustrates communication of the DLM 114 with one environment containing such as the edge nodes 102, central server 110, AI agents 104 associated with the edge nodes 102, and the like. However, in other embodiments, the DLM 114 may be coupled with more than one environment, wherein devices among the various environments may interact over a network with the DLM 114 such that the computer executable decisions and their respective decision lifecycles may be dependent on the inputs and evidence gathered from components and edge nodes 102 and devices from across the multiple environments, without limitations.

The hardware systems supporting the decision initiation module 204 include the edge computing devices configured to interface with the IoT-enabled sensors, wearable devices, or other data acquisition hardware deployed in the ecosystem. The edge computing devices may preprocess data, prioritize the triggering events based on the predefined criteria, and forward the processed inputs to the central server 110 or directly to the DLM 114 for token generation and lifecycle initiation. The central server 110 may be equipped with computational resources capable of executing cryptographic algorithms for tokenization and storing immutable records in a distributed ledger system, further ensuring compliance with audit and traceability requirements.

The integration of blockchain-based tokenization and FII assignment by the decision initiation module 204 allows the decisions initiated within the ecosystem to be securely tracked, verified, and integrated across both internal and external systems, thereby enhancing the overall reliability and auditability of this decision lifecycle management process.

The evidence aggregation module 210 of the decision lifecycle manager (DLM) 114 is configured to perform a systematic and distributed collection of the evidence required for informed decision-making in the next stage at 508. The evidence may be retrieved from the plurality of disparate and heterogeneous data sources such as the edge nodes 102 or the associated sensors or wearable devices or other hardware or software components, and the like. The data sources may include, but are not limited to, the edge nodes 102 deployed in the geographically distributed locations, cloud-based storage and computing platforms, centralized or decentralized databases associated with the edge nodes 102, and external third-party systems interfaced through application programming interfaces (APIs) with the edge nodes 102. The evidence aggregated by the evidence aggregation module 210 may include structured data (e.g., tabular datasets, relational database entries), unstructured data (e.g., text, images, videos), and sensor-generated inputs (e.g., telemetry, environmental readings, physiological measurements), or semi-structured data.

The aggregated evidence may also be tokenized through an application of a cryptographic blockchain-based process, whereby each discrete piece of the computer executable evidence may be assigned a unique and immutable evidence token (also referred to as token in context of evidence which is different from the token associated with the decision). This tokenization of the evidence may establish a direct and verifiable linkage between the evidence and the corresponding decision token generated during the decision initiation stage. The blockchain-based tokenization mechanism may allow each piece of the evidence to be tamper-proof, thereby enabling its authentication and traceability throughout the decision lifecycle. An association of the evidence token with the decision token may facilitate a comprehensive and audit-compliant framework, so that all evidence used in the decision-making is unequivocally traceable to its originating decision.

In order to extend the interoperability and integration capabilities of the ecosystem, the evidence may be further assigned a Foreign Integration Identifier (FII), similar to the FII assigned to the computer executable decisions. These may be referred to as evidence-specific FII and decision-specific FII. The evidence-specific FII may enable unique identification and synchronization of the evidence across multiple, potentially disparate systems to allow consistency and interoperability between the DLM 114 and external systems. The evidence-specific FII allows that the provenance and utilization of the evidence can be consistently tracked, even in scenarios involving cross-platform data exchange or multi-system interactions.

The evidence aggregation module 210 may operate through a hardware-enabled infrastructure comprising the edge computing devices, central server 110, and the cloud-based resources or cloud infrastructure 112. The edge nodes 102 may preprocess the locally collected evidence, reducing redundancy and noise before transmitting the data to the DLM 114 directly or through the cloud infrastructure 112. The central server 110 or the cloud infrastructure 112 may be equipped with computational resources for performing evidence tokenization and associating the evidence token with the corresponding decision tokens via a distributed ledger system. The blockchain and the distributed ledger system are further discussed later in the document. This allows that the evidence is securely stored and verifiable, with built-in mechanisms for real-time access and auditability by authorized parties as per predefined access rules.

The integration of the tokenization and the assignment of the evidence-specific FII within the evidence aggregation module 210 allows the decision lifecycle manager 114 to only collect and utilize the evidence in a secure and verifiable manner. This ensures operational and regulatory requirements are met for traceability, interoperability, and compliance.

Once the evidence is aggregated, at 510 the evidence validation module of the decision lifecycle manager (DLM) 114 may perform a rigorous process to ensure the accuracy, relevance, and integrity of the evidence utilized in the decision-making lifecycle. The evidence validation module may be configured to leverage specialized hardware systems, including artificial intelligence (AI) processing units such as graphics processing units (GPUs 214) or application-specific integrated circuits (ASICs) and the like. These hardware systems may be configured to execute advanced AI algorithms 216 and cryptographic processes that verify authenticity and reliability of the evidence, thereby reducing the risk of errors, inconsistencies, or biases during the decision-making process by the DLM 114.

The validation process may begin when the evidence, collected from the evidence aggregation module 210, is transmitted to the AI processing units of the DLM 114. The validation may involve a multi-layered computational analysis, which may include digital signature verification, integrity checks via cryptographic hashing, and contextual relevance assessments conducted using machine learning models. These processes may collectively ensure that the evidence adheres to predefined integrity and relevance criteria, as established by the DLM's operational protocols. The evidence that fails to meet these criteria may be flagged for review or discarded, ensuring that only validated evidence progresses to subsequent decision-making stages.

Upon successful validation, the evidence validation module may create the evidence tokens, each uniquely representing a validated piece of evidence. The evidence tokens may then be linked to the corresponding decision token, creating an immutable chain of custody for the decision lifecycle as discussed above. This linkage may be implemented using blockchain technology, where the evidence tokens and the decision token are recorded on the distributed ledger system to ensure tamper-proof traceability. The resulting chain of custody may provide a transparent mechanism through which any decision made by the DLM 114 can be traced back to the specific pieces of validated evidence that informed it.

The evidence validation module may be supported through hardware system that may be configured for high-throughput evidence validation, enabling real-time or near-real-time processing of voluminous datasets originating from the disparate data sources. For example, GPUs 214 and ASICs deployed in both the on-premise and the cloud-based infrastructures (or cloud infrastructure 112) may be operably coupled to the evidence aggregation module 210 and the DLM 114, thereby facilitating data flow and efficient computational processing. The validated evidence, along with its associated evidence tokens, may be securely stored in the distributed ledger for compliance with auditability and traceability requirements. The evidence validation module may integrate hardware-accelerated processing with blockchain-based traceability mechanisms so that the DLM 114 may operate with a high degree of accuracy, reliability, and transparency.

The AI-based analysis module 212 of the decision lifecycle manager (DLM) 114 may then be configured to process the evidence aggregated during the evidence collection phase and generate the decision recommendation at 512. The AI-based analysis module 212 may include sophisticated artificial intelligence (AI) algorithms, such as reinforcement learning models, natural language processing systems, and predictive analytics frameworks, which may be executed by the AI-based analysis module 212 integrated into the DLM 114. The AI-based analysis module 212 may include dedicated hardware components, including graphics processing units (GPUs 214), tensor processing units (TPUs), or custom-designed accelerators capable of performing high-complexity computations in real-time. The AI algorithms 216 may utilize historical data, predefined business rules, and current contextual information encapsulated within the decision token to identify optimal decision recommendations while accounting for dynamic environmental variables.

In embodiments requiring human oversight of the decision, the AI-based analysis module 212 may incorporate a Human-In-The-Loop (HITL) integration framework. The HITL integration may allow human decision-makers, referred to as human entities, to review, validate, and, if necessary, modify the AI-generated decision recommendation. The AI-based analysis module 212 may provide a secure and interactive interface through which the human decision makers may input additional contextual information, adjust decision parameters, or override the AI-generated decision recommendations. These interactions between the AI-based analysis module 212 and the human entities are systematically recorded and tokenized, so that every human intervention is traceable and associated with corresponding decision token for auditability and compliance purposes.

The HITL mechanism may include a controlled feedback loop wherein the human decision makers may exercise judgment to refine the AI-generated decision recommendations, thereby mitigating risks associated with autonomous decision-making. The traceable records maintain accountability, and the decision-making process remains transparent and auditable.

The AI-based analysis module 212 may further include a distributed decision processing unit, wherein decision analysis tasks may be offloaded to the edge nodes 102, cloud-based systems (also referred to as cloud infrastructure 112), or the central, depending on the computational requirements and latency constraints. The AI algorithms 216 deployed across the AI-based analysis module 212 may be dynamically updated based on the reinforcement learning methodologies, enabling the system to adapt the decision recommendations over time to optimize outcomes.

The AI-based analysis module 212 may be implemented through a combination of hardware and software components, including but not limited to, AI processors, encrypted communication interfaces, and secure storage units. This allows the AI-based analysis module 212 to operate as a robust, hardware-enabled system that provides reliable and verifiable decision recommendations.

Next, at 514, the DLM 114 may either automatically approve the decision or route it for manual approval by authorized stakeholders depending on the type of decision and its criticality. Automated decisions may often be used for routine tasks, while manual approval may be required for more complex or high-impact decisions. In some embodiments, the DLM 114 may include Digital Rights Management (DRM) rules to control access to the decision tokens and related evidence. This allows only authorized entities to approve or modify the decisions, such that the decision-making processes are secure and compliant with regulatory standards.

Next, after the decision is approved, the decision may be executed at 516 by relevant systems, such as automated actuators, business process management systems, or software services. The DLM 114 is configured to initiate the execution which may be carried out according to a predefined workflow and that any deviations in the execution may be detected and logged. The decision token may be updated to reflect its execution status, including timestamps and details of the actions taken during the execution of the decision in the predefined workflow. The execution phase is fully traceable and auditable. The Foreign Integration Identifier (FII) may be used to track the execution of the decision across multiple systems, so that the outcomes of the decision may be properly synchronized and integrated with the external systems.

The DLM 114 may collect the telemetry data from the hardware components, such as the edge nodes 102 and the AI agents 104, to monitor effectiveness of the decision. The telemetry data helps in evaluating whether the decision led to the desired outcomes and if any adjustments may be needed. The collected telemetry data may be used to refine the decision-making process through a continuous feedback loop. The reinforcement learning algorithms 218 may leverage this data to improve future decision recommendations and improve accuracy and efficiency over time. The feedback loop may include a generative AI system, which may continuously learn and adapt based on the outcomes of previous decisions, creating a dynamic decision-making environment.

The decision lifecycle manager (DLM) 114 may include a mechanism for generating and maintaining immutable records of the decisions and the associated evidence, leveraging blockchain-based tokenization to establish an incorruptible ledger. Through the blockchain mechanism, each decision and its corresponding lifecycle stages such as including initiation, evidence aggregation, AI-based analysis, manual or automated approvals, and execution may be recorded as discrete, immutable entries. Each entry in the blockchain ledger may be cryptographically linked to ensure that no record can be altered without invalidating its associated cryptographic chain, thereby creating a verifiable and tamper-proof history. This immutable record creation allows auditability, enabling a retrospective analysis of decision processes for internal governance and regulatory compliance purposes.

The DLM 114 may integrate a compliance reporting module, which may dynamically generate compliance documentation based on the immutable records. The compliance reporting module may systematically extract decision records, evidence tokens, approval statuses, execution details, and associated metadata to create a report that demonstrate adherence to regulatory frameworks, such as the General Data Protection Regulation (GDPR), Health Insurance Portability and Accountability Act (HIPAA), or industry-specific financial regulations. The compliance reporting module may be configured to interface with an SQL-centric resource surveillance component, which monitors decision data flows and access patterns in real-time. The SQL-centric resource surveillance component may be configured to ensure that data handling practices meet regulatory standards, including data privacy, integrity, and security requirements, and provides proactive alerts for potential non-compliance scenarios.

The Foreign Integration Identifier (FII) may be embedded within each decision and its corresponding evidence. The FII functions as a unique cross-platform identifier, enabling correlation of the decision tokens and the evidence across multiple, heterogeneous systems. This functionality is critical for cross-system audits to help auditors trace the end-to-end lifecycle of the decision, even when components of the decision-making process may involve the external platforms or third-party systems. The FII provides consistency and transparency by linking the decisions across systems, facilitating reconciliation of inter-system processes while maintaining compliance with predefined regulatory requirements.

The immutable record creation, compliance reporting, and cross-system auditing processes may be facilitated through a combination of hardware and software components. Blockchain tokenization and ledger management may be implemented using specialized hardware, such as secure processors and dedicated cryptographic modules, integrated within the DLM's on-premises and the cloud-based infrastructure (also referred to as cloud infrastructure 112). The SQL-centric surveillance module and the compliance reporting module may operate on computational hardware resources that may be equipped with database management capabilities for real-time processing and report generation.

In embodiments, the evidence aggregation module may further include the SQL-centric resource surveillance mechanism or the SQL-centric surveillance module that may be configured to monitor and analyze system resources, data inputs, and workflow execution associated with the plurality of data sources in real-time such that the resource surveillance mechanism uses SQL-based queries to gather the evidence in the form of computer-executable data.

The described mechanisms collectively enable the DLM 114 to function as a comprehensive and reliable system for managing decision lifecycles with built-in capabilities for auditability, compliance, and interoperability to address both operational and regulatory challenges in decision-making environments.

The system 100 addresses the specific technical challenge of maintaining decision integrity across distributed infrastructure with varying security and reliability profiles. By implementing cryptographic tokenization of both decisions and evidence through blockchain technology 602, 606, 614, the system 100 creates a tamper-evident chain of custody that persists even when decision components are processed across disparate edge nodes 102 with different trust levels. This technical approach solves the previously unsolved problem of maintaining traceable decision provenance in heterogeneous computing environments where components may experience intermittent connectivity or local compromise.

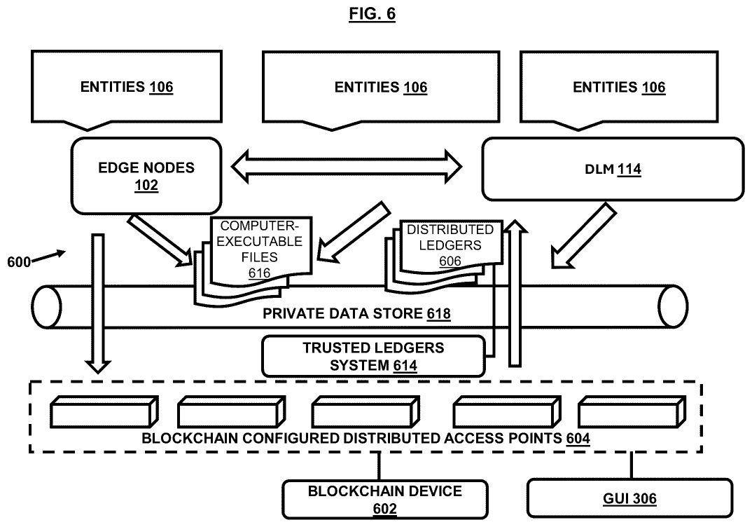

FIG. 6, with reference to FIGS. 1 through 5, illustrates an exemplary blockchain-configured ecosystem architecture 600 containing one or more components of the ecosystem 100 including such as the DLM 114 and the edge nodes 102, and additional components to ensure the integrity of transactions and digital data (including the decision token, evidence token, and the associated evidence) shared/processed during data transfer or storage, as previously discussed in this document without limitations. The blockchain-configured ecosystem architecture 600 provides a crowdsourced integrity network for storing data accessed, extracted, or transformed, for sharing or storing across a computer network. This approach contrasts with information stored locally by various participants or databases, which may be vulnerable to tampering.

The ecosystem architecture 600 may be blockchain-configured to incorporate various blockchain devices. For instance, the DLM 114 and the edge nodes 102 may interact with a blockchain device 602 through a plurality of blockchain-configured distributed access points 604. A network facilitating interaction among all components may be a blockchain integrity network, fostering trust among various participants, entities, systems, and components thereof, and their associated computing terminals or devices, even if the devices/terminals or machines do not have direct knowledge of one another. The blockchain network enables secure connections, transactions, recording, and sharing of data, information blocks, evidence, and tokens, including the decision and evidence tokens, through a trusted system. The blockchain maintains a record of transactions, data exchanges, and updates from various terminals/devices on distributed ledgers 606, which provides a tamper-resistant history to build trust among terminals/devices (such as those associated with various participants or nodes) enabling peer-to-peer or peer-to-client interactions through a distributed digital ledger technology system. The ecosystem architecture 600 includes a distributed trusted ledger system 614 containing the distributed blockchain ledgers 606, which are associated with a plurality of computing terminals and devices. Each ledger may store a copy of computer-executable files 616, which contain data inputs related to the edge nodes 102 and the decisions across the entire ecosystem such that the evidence etc is continuously tracked and recorded from the edge nodes 102, and other information relevant to the decision making is also tracked. This distributed ledger system 614 allows for rule-based contracts that execute when specified conditions are met.

The various computing terminals or devices in the network serve as distributed peer-to-peer nodes and connections. The DLM 114 and the edge nodes 102 and other components thereof of the ecosystem 100 may be configured to process context inputs and information blocks through the blockchain network based on defined rules. Each terminal/device/node in the ecosystem architecture 600 may receive a copy of the blockchain, which may be automatically downloaded upon joining the blockchain integrity network, thereby decentralizing the network. Every permissioned node or device in the network may act as an administrator of the blockchain, participating voluntarily in the decentralized network.

The blockchain mitigates risks associated with centralized data storage by distributing data across the network, which may include the computer-executable files 616 containing information blocks pertaining to the edge nodes 102 and other systems of the ecosystem 100, evidence, decision tokens etc. Security on the blockchain is achieved using encryption technology and validation mechanisms, which ensure data integrity. Public and private keys facilitate secure access, where a public key defines a user's address on the blockchain, and a private key enables access to digital assets within the network.

In an embodiment, the distributed ledgers 606 enable the coding of smart contracts (using smart contract systems) that execute upon the satisfaction of predefined conditions. These smart contracts may protect various data pieces associated with patient care and mitigate risks of unauthorized file copying and redistribution, ensuring patient privacy rights are maintained.

The blockchain-configured ecosystem architecture 600 may provide a private view for various devices and entities operating in the network through the private data store 618. This allows each permissioned device, such as the DLM 114 and the edge nodes 102 and systems associated with the entities, to privately access the computer-executable files 616 associated with specific tasks, user inputs, and care directives based on permissions granted according to each entity's identity and roles defined by the system. The DLM 114 and the edge nodes 102 and other systems associated with the entities may access these files through the private data store 618 via the distributed blockchain-configured access points 604, where each access point supports multi-party access based on defined rights.

The private data store 618 offers virtual storage to facilitate secure interaction, information exchange, review, and presentation of the computer-executable files 616. For example, the private data store 618 may allow the virtual presentation of only limited portions of executable files to specific entities, respecting permissions for access and review. The private data store 618 may be configured to auto-hash review interactions at defined intervals, ensuring that the computer-executable files 616 remain secure and private per access rights authorized to each node, while maintaining synchronization with permissioned access.

In an embodiment, the blockchain-configured digital ecosystem architecture 600 may incorporate a federated blockchain consisting of several entities/participants and their associated devices. These components jointly interact to process data transfers through a trusted, secure, and distributed network of blockchain-configured access points 604.

In an embodiment, the blockchain device 602 may include the distributed trusted ledger system 614 containing the distributed blockchain ledgers 606 associated with the computing terminals. Each ledger stores a copy of computer-executable files that include data about the edge nodes 102, the evidence, and other information about the edge nodes 102 and the decision process. This blockchain enabled information provides a verifiable record of interactions within the ecosystem 100, supporting the system's objectives by ensuring data integrity and transparency through the blockchain.

In various embodiments, the DLM 114 may implement a distributed decision coordination framework configured to ensure consistency and resolve conflicts in real-time through consensus algorithms such as RAFT or Paxos and the like. Parallel decision execution may be facilitated to facilitate multiple independent decision processes to operate simultaneously while dynamically allocating computational or operational resources to high-priority tasks.

In some embodiments, the DLM 114 may incorporate self-healing decision mechanisms configured to detect and/or autonomously correct errors through rollback and reprocessing functionalities. Decision recovery may be executed based on redundant evidence sources and alternative workflow pathways to ensure operational resilience.

The architecture 600 fundamentally transforms conventional computing systems into specialized decision orchestration networks through its unique integration of AI accelerators 214, blockchain security mechanisms 602, 606, 614, and edge computing components 102. The architectural arrangement creates a novel technical system that optimizes decision workflows in ways impossible with generic computing resources. For example, the architecture 600 automatically routes decision tasks with high security requirements to trusted execution environments with hardware-level isolation via the distributed ledger system 614, while computationally intensive but less sensitive analysis occurs on specialized AI accelerators 214. This technical orchestration creates measurable improvements in both security posture and computational efficiency compared to conventional systems.

In certain embodiments, a blockchain-based framework as discussed above in the document may be integrated to anchor decision-making evidence across multiple lifecycle stages, thereby establishing immutable provenance chains. In embodiments, such blockchain-integrated federated learning may be employed to securely aggregate AI model updates from distributed edge devices, ensuring data integrity and trust in decentralized decision processing.

The DLM 114 may include dynamically adaptive AI models configured to respond to changing inputs, regulatory requirements, and environmental conditions through context-aware embeddings. In some embodiments, explainable AI may be incorporated to generate human-readable justifications for each decision recommendation, thereby supporting localized language adaptation for diverse user bases.

The DLM 114 may support predefined decision templates designed for industry-specific workflows. These templates may be dynamically modifiable based on real-time feedback, operational outcomes, or regulatory updates without limitations to improve decision accuracy and/or efficiency.

The DLM 114 may employ ontology-based semantic evidence mapping techniques to categorize and/or process evidence from diverse sources systematically. In embodiments, provenance scoring methodologies may be utilized to assign reliability, relevance, and timeliness scores to collected evidence, thereby prioritizing higher-quality data sources in decision-making processes.

In various embodiments, predictive telemetry may be leveraged to enable future-driven decision-making. The DLM 114 may analyze real-time telemetry data to anticipate potential scenarios and facilitate proactive decision-making strategies to mitigate future challenges.

The DLM 114 may be implemented as a domain-agnostic framework configured to ensure cross-industry interoperability. Standardized APIs or middleware may enable seamless integration with legacy systems and third-party platforms.

In embodiments, user-specific insights may be generated to tailor decision recommendations based on individual roles, user preferences, or historical interactions. Further, collaborative interfaces may be incorporated to enable team-based real-time review or refinement of decision outcomes, with tracked modifications and tokenized revision history.

A zero-trust decision framework may be implemented along with the DLM 114 to authenticate interaction with each external system for the protection of sensitive data. In some embodiments, the DLM 114 may incorporate dynamic security posture adjustments, wherein security configurations may be automatically modified based on criticality of the decision and real-time threat assessments.

In certain embodiments, the DLM 114 may be designed as a modular framework with plug-and-play components, enabling selective adoption, removal, or replacement of individual system features. In embodiments, industry-specific feature packs may be downloadable to provide specialized functionalities tailored to specific operational domains.

The DLM 114 may integrate gamification strategies to incentivize human feedback participation. Incentives such as points, badges, or other reward mechanisms and the like without limitations may be utilized to improve engagement or improve overall decision quality.

In embodiments, decision simplification AI may be employed to break down complex scenarios into smaller decision components, thereby prioritizing critical decision paths for more effective human review.

In some embodiments, environmental sensor integration may be utilized to dynamically adjust decision-making processes based on live IoT metrics, including but not limited to weather conditions, energy availability, or external environmental factors.

The DLM 114 may incorporate multi-modal evidence ingestion mechanisms to process or integrate diverse input types such as video, audio, telemetry, or sensor data streams without limitations into unified analytical workflows.

In embodiments, bias detection or mitigation methodologies may be embedded within the DLM 114 to identify potential algorithmic biases or dataset inconsistencies. The DLM 114 may suggest corrective actions or facilitate compliance audits to ensure ethical AI decision-making.

In some embodiments, the DLM 114 may include dynamic compliance mechanisms capable of automatically updating regulation templates or reporting structures in response to newly issued legal or regulatory requirements.

The various components described herein and/or illustrated in the figures may be embodied as hardware-enabled modules and may be a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The modules that include electronic circuits process computer logic instructions capable of providing digital and/or analog signals for performing various functions as described herein. The various functions can further be embodied and physically saved as any of data structures, data paths, data objects, data object models, object files, database components. For example, the data objects could include a digital packet of structured data. Example data structures may include any of an array, tuple, map, union, variant, set, graph, tree, node, and an object, which may be stored and retrieved by computer memory and may be managed by processors, compilers, and other computer hardware components. The data paths can be part of a computer CPU that performs operations and calculations as instructed by the computer logic instructions. The data paths could include digital electronic circuits, multipliers, registers, and buses capable of performing data processing operations and arithmetic operations (e.g., Add, Subtract, etc.), bitwise logical operations (AND, OR, XOR, etc.), bit shift operations (e.g., arithmetic, logical, rotate, etc.), complex operations (e.g., using single clock calculations, sequential calculations, iterative calculations, etc.). The data objects may be physical locations in computer memory and can be a variable, a data structure, or a function. Some examples of the modules include relational databases (e.g., such as Oracle® relational databases), and the data objects can be a table or column, for example. Other examples include specialized objects, distributed objects, object-oriented programming objects, and semantic web objects. The data object models can be an application programming interface for creating HyperText Markup Language (HTML) and Extensible Markup Language (XML) electronic documents. The models can be any of a tree, graph, container, list, map, queue, set, stack, and variations thereof, according to some examples. The data object files can be created by compilers and assemblers and contain generated binary code and data for a source file. The database components can include any of tables, indexes, views, stored procedures, and triggers.

In an example, the embodiments herein can provide a computer program product configured to include a pre-configured set of instructions, which when performed, can result in actions as stated in conjunction with various figures herein. In an example, the pre-configured set of instructions can be stored on a tangible non-transitory computer readable medium. In an example, the tangible non-transitory computer readable medium can be configured to include the set of instructions, which when performed by a device, can cause the device to perform acts similar to the ones described here.

The embodiments herein may also include tangible and/or non-transitory computer-readable storage media for carrying or having computer-executable instructions or data structures stored thereon. Such non-transitory computer readable storage media can be any available media that can be accessed by a general purpose or special purpose computer, including the functional design of any special purpose processor as discussed above.

By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a special purpose computer or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network. If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

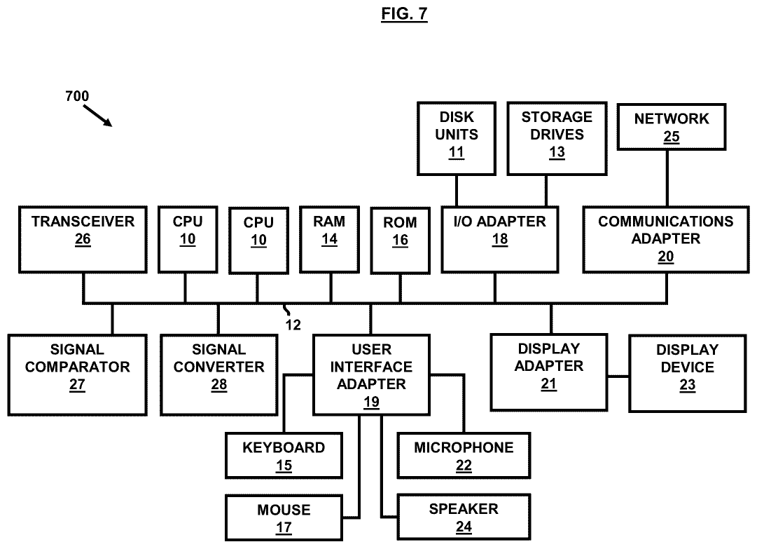

A representative hardware environment for practicing the embodiments herein is depicted in FIG. 7, with reference to FIGS. 1 through 6. This schematic drawing illustrates a hardware configuration of an information handling/computer system 700 in accordance with the embodiments herein.

The system 700 comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system 700 can read the inventive instructions on the program storage devices and follow these instructions to execute the methodology of the embodiments herein. The system 700 further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network, and a display adapter 21 connects the bus 12 to a display device 23 which may be embodied as an output device such as a monitor, printer, or transmitter, for example. Further, a transceiver 26, a signal comparator 27, and a signal converter 28 may be connected with the bus 12 for processing, transmission, receipt, comparison, and conversion of electric or electronic signals.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the present invention.

What is claimed is:

1. A computer-controlled decision lifecycle management system for orchestrating a decision lifecycle, the system comprising:
a decision categorization module that classifies a decision type as one of a decision made by a manual intervention, a decision made autonomously by an artificial intelligence (AI) system, or a decision made collaboratively by both an AI system and the manual intervention, based on a set of predefined criteria;
a decision initiation module that triggers an initiation of the decision based on a triggering event, wherein the triggering event comprises one or more of a hardware input, a user request, a predefined schedule, wherein the decision initiation module is to generate a decision token representing the decision;
an evidence aggregation module communicatively coupled to a plurality of data sources distributed across discrete and remote locations, wherein the evidence aggregation module is to collect evidence in the form of computer-executable data from the plurality of data sources and associate the evidence with a decision token to enable traceability; and
an AI-based analysis module that processes the evidence by executing one or more AI algorithms and generate a computer executable decision recommendation based on processed evidence.

2. The system of claim 1, comprising:
a decision approval module that receives the decision recommendation and facilitate either automated or manual approval based on one or more predefined approval rules, wherein the decision token is updated upon approval to reflect an approval status; and
a decision execution module that executes the decision upon approval by triggering one or more actions, wherein the execution includes activating a hardware component, and updating the decision token to reflect an execution status.

3. The system of claim 2, wherein the decision execution module is to execute the decision upon the approval by triggering the one or more actions, and wherein the execution includes requesting a user for manual performance to conduct the execution and updating the decision token to reflect the execution status accordingly.

4. The system of claim 2, comprising an audit and compliance module that records an immutable and verifiable record of the decision lifecycle, including the evidence, the decision recommendation, the approval status, and the execution status, stored on a blockchain ledger for auditability and compliance with one or more predefined requirements.

5. The system of claim 2, wherein the decision execution module comprises:
a hardware actuator interface that receives one or more execution instructions and trigger a physical operation in the hardware component; and
a monitoring subsystem that collects telemetry data during the execution and update the decision token with one or more operational metrics and detected anomalies.

6. The system of claim 5, wherein the hardware component comprises one or more of a wearable device, a medical device, a continuous monitoring device, a drug delivery device, a surgical equipment, a therapeutic equipment, and a diagnostic device, and edge node associated with a user.

7. The system of claim 1, wherein the evidence aggregation module is to:
tokenize the evidence using a blockchain function to create a unique, immutable identifier for each piece of the evidence; and
transmit a tokenized evidence to a distributed ledger for secure storage and retrieval, such that the tokenized evidence is tamper-proof and accessible for audit and traceability.

8. The system of claim 1, wherein the AI-based analysis module is to:
perform a real-time analysis of the evidence by leveraging edge computing resources deployed at the remote locations of the data sources; and
adapt the decision recommendation dynamically based on changing inputs, using a reinforcement learning algorithm to optimize decision-making over time, wherein the changing inputs comprises one or more of the predefined criteria and the evidence collected from the data sources.

9. The system of claim 1, wherein the decision categorization module is to:
dynamically update the predefined criteria for decision classification based on historical decision outcomes and performance metrics stored in a decision analytics repository; and
notify the decision initiation module when a reclassification of the decision type is required.

10. The system of claim 1, wherein the decision initiation module comprises:
a sensor integration interface that receives data streams from one or more of an IoT-enabled device, a wearable device, data stream serving as the triggering events for initiating the decision; and
a priority assignment mechanism that ranks multiple simultaneous triggering events based on a predefined priority hierarchy.

11. The system of claim 1, wherein the evidence aggregation module is to:
validate an integrity of the collected evidence using a digital signature verification process; and
filter irrelevant or redundant data prior to associating it with the decision token to improve processing efficiency.

12. The system of claim 4, wherein the audit and compliance module is to:
track an access permission to data corresponding to the decision lifecycle using a role-based access control mechanism; and
log user interactions with the data, including one or more of modifications and approvals.

13. The system of claim 1, wherein the evidence aggregation module comprises a SQL-centric resource surveillance mechanism that monitors and analyzes system resources, data inputs, and workflow execution associated with the plurality of data sources in real-time, and wherein the resource surveillance mechanism uses SQL-based queries to gather the evidence in the form of computer-executable data.

14. A computer-implemented method for managing a decision lifecycle, the method comprising:
classifying, by a decision categorization module, a decision type as one of a decision made by a manual intervention, a decision made autonomously by an artificial intelligence (AI) system, or a decision made collaboratively by both the AI system and the manual intervention, based on predefined classification criteria;
triggering, by a decision initiation module, an initiation of the decision in response to a triggering event, wherein the triggering event includes one or more of a hardware input, a user request, or a predefined schedule, and generating a decision token representing the decision;
collecting, by an evidence aggregation module communicatively coupled to a plurality of data sources distributed across discrete and remote locations, evidence in the form of computer-executable data from the plurality of data sources and associating the evidence with the decision token for traceability;
processing, by an AI-based analysis module, the evidence by executing one or more AI algorithms to generate a computer-executable decision recommendation; and
updating the decision token to reflect the status of the decision lifecycle stages.

15. The method of claim 14, comprising:
receiving, by a decision approval module, the decision recommendation;
approving the decision through one or more predefined approval rules, wherein the approval process is either automated or involves manual intervention; and
updating the decision token to reflect the approval status.

16. The method of claim 14, comprising:
executing, by a decision execution module, the approved decision by triggering one or more actions, wherein the execution includes activating a hardware component or requesting manual performance of the execution; and
updating the decision token to reflect an execution status based on the performed actions.

17. The method of claim 14, wherein the collecting of the evidence by the evidence aggregation module comprises:
tokenizing the evidence using a cryptographic hash function to create a unique and immutable identifier; and
storing the tokenized evidence on a distributed ledger for tamper-proof auditability and traceability.

18. The method of claim 14, wherein the processing of the evidence by the AI-based analysis module comprises:
performing a real-time analysis of the evidence by leveraging edge computing resources deployed at the remote locations of the data sources; and
dynamically adapting the decision recommendation based on changing inputs including at least the evidence using a reinforcement learning algorithm.

19. The method of claim 14, wherein the AI-based analysis module utilizes hardware acceleration components including at least one of specialized graphics processing units (GPUs) and field-programmable gate arrays (FPGAs) to execute computationally intensive AI algorithms, and wherein processing of the evidence comprises:
distributing computational tasks between the edge computing resources and central processing resources based on latency requirements and computational complexity;
routing security-sensitive decision tasks to trusted execution environments with hardware-level isolation; and
executing less sensitive but computationally intensive analysis on specialized AI accelerators,
wherein the distribution of computational tasks creates measurable improvements in both decision throughput and response times compared to centralized decision processing.

20. The method of claim 14, comprising:
implementing a federated learning framework that enables the AI-based analysis module to learn from distributed data sources across the edge nodes without compromising data privacy;
utilizing a multi-layered adaptive security framework that dynamically adjusts security measures based on a criticality level of the decision being processed and real-time threat assessments;
collecting telemetry data from hardware components through a monitoring subsystem that enables continuous evaluation of decision effectiveness and automatic refinement of future decision processes; and
providing a graphical user interface that allows authorized users to visualize decision paths, associated evidence, and real-time adjustments to the decision workflow.
